(19) United States
(12) Patent Application Publication
(10) Pub. No.: US 2025/0091938 A1
(43) Pub. Date: Mar. 20, 2025

(54) SILICA-FREE TUNGSTEN BRONZE GLASS CERAMICS AND METHODS OF MAKING THE SAME

(71) Applicant: CORNING INCORPORATED, CORNING, NY (US)

(72) Inventor: Jesse Kohl, Horseheads, NY (US)

(21) Appl. No.: 18/886,355

(22) Filed: Sep. 16, 2024

Related U.S. Application Data
(60) Provisional application No. 63/583,999, filed on Sep. 20, 2023.

(51) Int. Cl. C03C 10/00

(52) U.S. Cl. CPC C03C 10/0054; C03C 2214/20

(57) ABSTRACT

A glass-ceramic that includes: 5 mol %≤Al₂O₃≤40 mol %; 30 mol %≤B₂O₃≤60 mol %; 10 mol %≤WO₃≤50 mol %; 0 mol %≤SnO₂≤5 mol %; and 1 mol %≤R₂O≤30 mol %, wherein R₂O is one or more of Li₂O, Na₂O, K₂O, Rb₂O, and Cs₂O. Further, the glass-ceramic can be silica-free and, in some cases, can have a thickness from about 0.05 mm to about 0.5 mm and one or more of: (a) a total transmittance of less than or equal to 4% at ultraviolet (UV) wavelengths below 400 nm and (b) a total transmittance from about 0.5% to about 4% in the near-infrared (NIR) spectrum from 700 nm to 1500 nm.

### CROSS-REFERENCE TO RELATED APPLICATIONS

This application claims the benefit of priority under 35 U.S.C. § 119 of U.S. Provisional Application Ser. No. 63/583,999 filed on Sep. 20, 2023, the content of which is relied upon and incorporated herein by reference in its entirety.

### FIELD OF THE DISCLOSURE

The disclosure relates to glass-ceramics and glass-ceramic articles with UV- and NIR-blocking attributes, and more particularly, glass-ceramics and glass-ceramic articles that comprise silica-free tungsten bronze compositions for use in various applications, including glazing. The disclosure also relates to methods of making these glass-ceramics and glass-ceramic articles.

### BACKGROUND

Near infrared (NIR) shielding glasses are being employed to block wavelengths ranging from 700-2500 nm for applications including optical filters, lenses, and glazing for automotive, architectural, medical, defense, aerospace, and other consumer applications. In the case of architectural and automotive glazing, decreasing the amount of ultraviolet (UV) and NIR transmission reduces energy consumption because there is a reduced demand for air conditioning, further decreasing the emission of greenhouse gases. This is especially significant for all-electric vehicles currently for sale and in development. With the trend toward utilizing thinner glass for automotive and architectural glazing, improved light management of UV and NIR radiation may be developed in tandem to fully leverage the benefit of thin glass. This is due to the fact that as the path length of the glazing is decreased, the amount of light transmittance increases.

Accordingly, there is a need for low cost glass and/or glass-ceramic materials and articles that exhibit optical properties suitable for various UV- and IR-shielding applications (e.g., architectural glazing and automotive glazing applications).

### SUMMARY

According to an aspect of the disclosure, a glass-ceramic is provided that comprises:
5 mol %≤Al₂O₃≤40 mol %;
30 mol %≤B₂O₃≤60 mol %;
10 mol %≤WO₃≤50 mol %;
0 mol %≤SnO₂≤5 mol %; and
1 mol %≤R₂O≤30 mol %, wherein R₂O is one or more of Li₂O, Na₂O, K₂O, Rb₂O, and Cs₂O.

According to an aspect of the disclosure, a glass-ceramic is provided that comprises:
7 mol %≤Al₂O₃≤30 mol %;
35 mol %≤B₂O₃≤55 mol %;
15 mol %≤WO₃≤40 mol %;
0 mol %≤SnO₂≤2.5 mol %; and
5 mol %≤R₂O≤25 mol %, wherein R₂O is one or more of Li₂O, Na₂O, K₂O, Rb₂O, and Cs₂O.

According to an aspect of the disclosure, a method of making a glass-ceramic is provided that includes the following steps:
mixing a batch comprising:
   5 mol %≤Al₂O₃≤40 mol %;
   30 mol %≤B₂O₃≤60 mol %;
   10 mol %≤WO₃≤50 mol %;
   0 mol %≤SnO₂≤5 mol %; and
   1 mol %≤R₂O≤30 mol %, wherein R₂O is one or more of Li₂O, Na₂O, K₂O, Rb₂O, and Cs₂O;
melting the batch between about 1100° C. and about 1450° C. to form a melt;
annealing the melt between about 380° C. and about 500° C. to define an annealed melt; and
heat treating the annealed melt between about 500° C. and about 1000° C. from about 5 minutes to about 48 hours to form the glass-ceramic.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

FIG. 1 is a cross-sectional view of an article including a substrate comprising a glass-ceramic composition, according to one or more embodiments of the disclosure;

FIG. 2 is a plot of optical transmission spectra for two glass-ceramic compositions, according to one or more embodiments of the disclosure;

FIGS. 3A and 3B are respective x-ray diffraction (XRD) plots for the two glass-ceramic compositions of FIG. 2, according to one or more embodiments of the disclosure;

FIGS. 4A-4D are transmission electron microscopy (TEM) micrographs of one of the glass-ceramic compositions of FIG. 2, according to one or more embodiments of the disclosure; and

FIG. 5 is a plot of an optical transmission spectrum for a comparative glass-ceramic composition.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, and/or the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As also used herein, the terms “glass article,” “glass articles,” “glass-ceramic article” and “glass-ceramic articles” are used in their broadest sense to include any object made wholly or partly of glass and/or glass-ceramics. Unless otherwise specified, all compositions are expressed in terms of mole percent (mol %). Coefficients of thermal expansion (CTE) are expressed in terms of 10⁻⁷/° C. and represent a value measured over a temperature range from about 20° C. to about 300° C., unless otherwise specified.

As used herein, “transmission”, “transmittance”, “optical transmittance” and “total transmittance” are used interchangeably in the disclosure and refer to external transmission or transmittance, which takes absorption, scattering and reflection into consideration. Fresnel reflection is not factored out of the transmission and transmittance values reported herein. In addition, any total transmittance values referenced over a particular wavelength range are given as an average of the total transmittance values measured over the specified wavelength range.

As used herein, “a glassy phase” refers to an inorganic material within the glass and glass-ceramic articles of the disclosure that is a product of fusion that has cooled to a rigid condition without crystallizing.

As used herein, “a crystalline phase” refers to an inorganic material within the glass and glass-ceramic articles of the disclosure that is a solid composed of atoms, ions or molecules arranged in a pattern that is periodic in three dimensions. Further, “a crystalline phase” as referenced in this disclosure, unless expressly noted otherwise, is determined to be present using the following method. First, powder x-ray diffraction (“XRD”) is employed to detect the presence of crystalline precipitates. Second, Raman spectroscopy (“Raman”) is employed to detect the presence of crystalline precipitates in the event that XRD is unsuccessful (e.g., due to size, quantity and/or chemistry of the precipitates). Optionally, transmission electron microscopy (“TEM”) is employed to visually confirm or otherwise substantiate the determination of crystalline precipitates obtained through the XRD and/or Raman techniques.

As further used herein, the terms “silica-free”, “selenium-free” and “cadmium-free” are used in the context of the as-formed glass-ceramics and glass-ceramic articles of the disclosure to denote that no silica-, selenium-, and/or cadmium-containing constituents are intentionally added to the batch of precursor constituents used to form the glass-ceramic in question. Nevertheless, as understood by those skilled the field of the disclosure, the resulting glass-ceramics and glass-ceramic articles of the disclosure may be silica-, selenium-, and/or cadmium-free while still containing trace amounts of silica, selenium and/or cadmium (e.g., as inadvertently included in other precursor batch constituents, from contamination, etc.).

As it relates to the glass-ceramic and glass-ceramic materials and articles of the disclosure, compressive stress and depth of compression (“DOC”) are measured by evaluating surface stress using commercially available instruments, such as the FSM-6000, manufactured by Orihara Co., Lt. (Tokyo, Japan), unless otherwise noted herein. Surface stress measurements rely upon the accurate measurement of the stress optical coefficient (“SOC”), which is related to the birefringence of the glass. SOC in turn is measured according to a modified version of Procedure C, which is described in ASTM standard C770-98 (2013) (“modified Procedure C”), entitled “Standard Test Method for Measurement of Glass Stress-Optical Coefficient,” the contents of which is incorporated herein by reference in its entirety. The modified Procedure C includes using a glass or glass-ceramic disc as the specimen having a thickness of 5 to 10 mm and a diameter of 12.7 mm. The disc is isotropic and homogeneous, and is core-drilled with both faces polished and parallel. The modified Procedure C also includes calculating the maximum force, Fₘₐₓ, to be applied to the disc. The force should be sufficient to produce at least 20 MPa compression stress. Fₘₐₓ is calculated using the equation:

$${F}_{max} = 7.85 {4}^{*} {D}^{*} h$$

where Fₘₐₓ is the maximum force (N), D is the diameter of the disc (mm), and h is the thickness of the light path (mm). For each force applied, the stress is computed using the equation:

$$σ ( MPa ) = 8 F / ( π * D * h )$$

where F is the force (N), D is the diameter of the disc (mm), and h is the thickness of the light path (mm).

As an example of a conventional light management technology, reflective coatings and films (commonly referred to as low-emissivity (low-E) coatings) have been employed on glass substrates. Low-E coatings minimize the amount of UV and NIR light that can pass through glass, without compromising the amount of visible light that is transmitted. There are currently two basic processes for making low-E coatings—sputtered and pyrolytic. Sputtered coatings are typically produced as multilayered coatings (e.g., 3-13 layers) that are typically comprised of metals (commonly silver), metal oxides, and metal nitrides. Because silver is an inherently soft material and susceptible to corrosion, the coating must be surrounded by other materials (barrier layers) to prevent exposure to ambient air. Thus, sputtered coatings were historically described as “soft-coat, low-E coatings” because they offered little resistance to chemical or mechanical attack. As such, most sputtered coatings are not sufficiently durable to be used in monolithic, light management applications. Further, light management technologies that rely on low-E coatings are typically high in cost, given the level of process complexity needed to produce them and the additional layers that must be added to fully achieve the optical requirements of the application.

A typical pyrolytic coating is a metallic oxide, most commonly tin oxide with some additives, bonded to the glass while it is in a semi-molten state. The result is a ‘baked-on’ surface layer that is quite hard and durable, which is why pyrolytic low-E coatings are sometimes referred to as “hard-coat, low-E coatings”. These pyrolytic coatings can be exposed to ambient air and cleaned with traditional glass cleaning products and techniques without damaging the coating. Because of their inherent chemical and mechanical durability, pyrolytic coatings have had some success in monolithic, light management applications, specifically for architecture. Nevertheless, these pyrolytic coating-related, light management technologies are also high in raw material and process-related cost, and do not perform as well as sputtered low-E coatings.

While low-E reflective coating technologies have been widely used in architecture for decades, these technologies have not been adopted by the automotive industry, particularly automotive glazing manufacturers. As highlighted earlier, the primary reason for the lack of penetration of low-E reflective coating technologies is cost. Besides having cost drawbacks, reflective coating technologies also pose several technical challenges when deployed in automotive glazing. They may require moisture protection and, in turn, careful sealing of the laminate edges. They typically impart visible color(s) in reflection, and not the desired neutral grey hue. Additionally, it is more costly to coat a curved part (e.g., an automotive moon roof) than a planar one.

It has also been demonstrated that thin films, coatings, and composite materials containing some volume fraction of nano- or micron-sized particles of non-stoichiometric tungsten suboxides or doped non-stoichiometric tungsten trioxides (referred to as “tungsten bronzes”) provide excellent NIR shielding with high transparency in the visible regime. Though referred to as a ‘bronze’, the tungsten bronzes are not structurally or chemically related to metallic bronze, which is an alloy of copper and tin. Rather, tungsten bronzes are in fact a group of non-stoichiometric tungsten sub-oxides that take the general chemical form MₓWO₃, where M=H, NH₄, Li, Na, K, Rb, Cs, Ca, Sn, Ag, Ln and 0<x<1. The disadvantages of the currently documented tungsten bronze films are their cost, often requiring vacuum deposition chambers, limited mechanical robustness, and susceptibility to oxygen, moisture, and UV light, which causes their NIR shielding performance to degrade. Additionally, films of tungsten bronze (provided they are deposited on a thermally stable substrate) cannot withstand temperatures exceeding 350° C. because they will oxidize in air.

Further, tungsten bronze particles have been encapsulated, blended into polymers, and/or laminated between two glazing panels making them impervious to the effects of moisture or UV light. Monolithic lenses and filters have also been made with polymer blends containing tungsten bronze particles. Yet, these panels, lenses, and filters have only been stable to temperatures approaching 230° C. due to degradation of the polymer matrix.

There are also several unconventional glass forming systems (tungsten-phosphates, alkali-tungsten-borates, and alkali-tungstates) that contain reduced tungsten oxide, alkali tungsten bronzes, and hydrogen tungsten bronzes when heat treated under reducing conditions. However, in these glass forming systems, only the outermost 5-20 micrometers (μm) contained a tungsten bronze. Many of these glasses are also hygroscopic and are not sufficiently mechanically, thermally, or chemically robust for most commercial applications. Additionally, the samples which exhibit hydrogen tungsten bronzes slowly bleach as the hydrogen diffuses out of the glass.

More recently, internally-nucleated, monolithic alkali- and silica-containing tungsten bronze glass ceramic (GC) materials have been made in a conventional melt quench glass melting process that provide UV shielding, optical transparency in the visible regime, and strong NIR attenuation. These GC materials have been evaluated for automotive applications and have exhibited optical properties that are superior than the foregoing, absorptive media technologies. A principal disadvantage of these GC compositions, however, is their costly manufacturing processes (e.g., high melting temperatures that exceed 1450° C.). Further, a substantial portion of the tungsten (a relatively expensive constituent) that is batched remains dissolved in the glass as a 6+ cation and does not provide UV or NIR absorbance.

Generally, the present disclosure is directed to glass-ceramics and glass-ceramic articles with UV- and NIR-blocking attributes, and more particularly, glass-ceramics and glass-ceramic articles with silica-free tungsten bronze compositions. Further, these silica-free tungsten bronze GC compositions and articles provide higher optical absorbance (and lower transmittance) than their silica-containing analogs (thus providing more solar shielding per dollar). Finally, the disclosure also relates to methods of making these glass-ceramics and glass-ceramic articles. Notably, these GC compositions and articles can be manufactured at lower cost because of their substantially lower melting temperatures and require no complicated forming process to be produced.

More specifically, the glass-ceramic materials and articles of the disclosure are alkali-doped, alumino-borate systems with tungstate crystalline phase(s). Typically, these GCs are silica-free. In one aspect, the GC includes: 5 mol %≤Al₂O₃≤40 mol %; 30 mol %≤B₂O₃≤60 mol %; 10 mol %≤WO₃≤50 mol %; 0 mol %≤SnO₂≤5 mol %; and 1 mol %≤R₂O≤30 mol %, wherein R₂O is one or more of Li₂O, Na₂O, K₂O, Rb₂O, and Cs₂O. In another aspect, the GC includes: 7 mol %≤Al₂O₃≤30 mol %; 35 mol %≤B₂O₃≤55 mol %; 15 mol %≤WO₃≤40 mol %; 0 mol %≤ SnO₂≤2.5 mol %; and 5 mol %≤R₂O≤25 mol %. In a further aspect, the GC includes: 11.5 mol %≤Al₂O₃≤24.5 mol %; 44 mol %≤B₂O₃≤49 mol %; 20 mol %≤WO₃≤25 mol %; 0 mol %≤SnO₂≤0.25 mol %; and 13 mol %≤R₂O≤19.5 mol %. In an implementation of any of these GC compositions, R₂O is one or more of Li₂O and Na₂O.

The GC materials and articles of the disclosure, as sized to a thickness from about 0.05 mm to 0.5 mm or 0.5 mm to 5 mm, exhibit one or more of: (a) a total transmittance of less than or equal to 4% at UV wavelengths below 400 nanometers (nm) and (b) a total transmittance from about 0.5% to about 4% in the NIR spectrum from 700 nm to 1500 nm. Further, the GC materials and articles of the disclosure can exhibit a total transmittance of at least 0.5% in the visible (VIS) spectrum from 400 nm to 700 nm. One advantage of these GC compositions is that they exhibit both strong and tunable UV, visible (VIS) and NIR absorbance. Tunability of these GCs can be effected through composition choice within the specified constituent ranges and/or post-forming thermal treatment (e.g., ceramming). Further, these GCs melt at lower temperatures than the prior-developed silicate tungsten bronze GCs, making them less costly to produce and for use as additives in solar shielding applications.

Moreover, without being bound by theory, these GCs are believed to provide enhanced resistance to moisture and oxygen as compared to their crystalline phases viewed in isolation, thus enabling their potential uses as additives for solar shielding. In addition, because of their strong absorbance in the NIR and UV spectra, these GCs are believed to be suitable for use in laser scaling frit applications. That is, a laser operating in a certain wavelength range (e.g., NIR or UV) can be paired with these GCs to effect localized melting of these GCs given their high absorbance in the same spectral range. Moreover, again without being bound by theory, these GCs may also be of benefit in these laser sealing frit applications because they tend to have high VIS transmittance after laser heating, which may result in partial or complete dissolution of the crystals that give rise to strong visible absorbance.

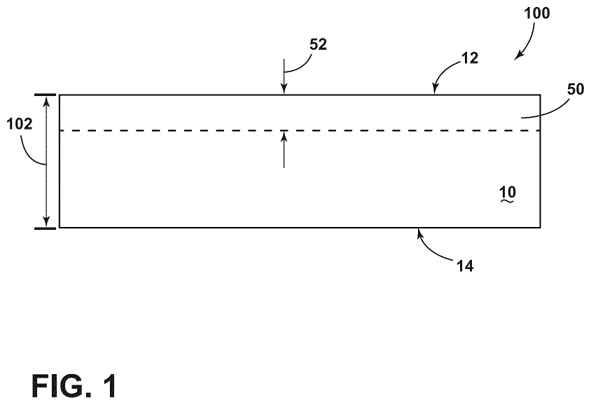

Referring now to FIG. 1, an article 100 is depicted that includes a substrate 10 with a thickness 102 and comprising a glass-ceramic composition, according to the disclosure. These articles can be employed in any of the applications outlined earlier (e.g., various glazing applications including, but not limited to, vehicular sunroofs, moonroofs, panoramic roofs, windows, and other sunroof-like panels, etc.). Accordingly, the substrate 10 can, in some implementations, have a thickness 102 that ranges from about 0.05 millimeters (mm) to about 5 mm. In some embodiments, the substrate 10 has a thickness 102 that ranges from 0.05 mm to about 5 mm, from about 0.05 mm to about 4 mm, from about 0.05 mm to about 3 mm, from about 0.05 mm to about 2 mm, from about 0.05 mm to about 1 mm, from about 0.05 mm to about 0.5 mm, from about 0.05 mm to about 0.25 mm, from about 0.05 mm to about 0.2 mm, from about 0.1 mm to about 5 mm, from about 0.1 mm to about 4 mm, from about 0.1 mm to about 3 mm, from about 0.1 mm to about 2 mm, from about 0.1 mm to about 1 mm, from about 0.1 mm to about 0.5 mm, from about 0.1 mm to about 0.25 mm, and all thickness values between these thickness range endpoints. Further, in embodiments of the article 100 depicted in FIG. 1, the substrate 10 may have a selected length and width, or diameter, to define its surface area. The substrate 10 may have at least one edge between primary surfaces 12, 14 of the substrate 10 defined by its length and width, or diameter.

Accordingly, the substrate 10 depicted in FIG. 1 can, in some embodiments, comprise a thickness 102 that ranges from about 0.05 mm to about 0.5 mm and a total transmittance of at least 0.5% in the visible spectrum from 400 nm to 700 nm. Further, in some implementations, the total transmittance can vary from about 0.5% to about 30%, from about 0.5% to about 25%, from about 0.5% to about 20%, from about 0.5% to about 15%, from about 0.5% to about 10%, and all values between these transmittance levels, in the visible spectrum from 400 nm to 700 nm.

Referring again to the substrate 10 depicted in FIG. 1, the substrate 10 can also comprise a thickness 102 that ranges from about 0.05 mm to about 0.5 mm and a total transmittance from about 0.5% to about 8%, or from 0.5% to about 4%, in the near infrared (NIR) spectrum from 700 nm to 1500 nm. In some implementations, the total transmittance can vary from about 0.5% to about 8%, from about 0.5% to about 7%, from about 0.5% to about 6%, from about 0.5% to about 5%, from about 0.5% to about 4%, from about 0.5% to about 3.5%, from about 0.5% to about 3%, from about 0.5% to about 2.5%, from about 0.5% to about 2%, and all values between these transmittance levels, in the NIR spectrum from 700 nm to 1500 nm. Further, according to some embodiments, the total transmittance can vary from about 0.5% to 9%, 0.5% to 8%, 0.5% to 7%, 0.5% to 6%, 0.5% to 5%, and all values between these transmittance levels, in the NIR spectrum from 700 nm to 2400 nm.

In addition, the substrate 10 can comprise a thickness 102 that ranges from about 0.05 mm to about 0.5 mm and a total transmittance of less than or equal to 4% at ultraviolet wavelengths (UV) below 400 nm. In implementations, the total transmittance can be less than or equal to 4%, less than or equal to 3.5%, less than or equal to 3%, less than or equal to 2%, less than or equal to 1%, less than or equal to 0.8%, less than or equal to 0.6%, and all other values within these ranges, at UV wavelengths below 400 nm.

Referring again to FIG. 1, the substrate 10 comprises a pair of opposing primary surfaces 12, 14. In some embodiments of the article 100, the substrate 10 comprises a compressive stress region 50. As shown in FIG. 1, the compressive stress region 50 extends from the primary surface 12 to a first selected depth 52 in the substrate. Nevertheless, some embodiments (not shown) include a comparable compressive stress region 50 that extends from the primary surface 14 to a second selected depth (not shown). Further, some embodiments (not shown) include multiple compressive stress regions 50 extending from the primary surfaces 12, 14 and/or edges of the substrate 10.

As used herein, a “selected depth” (e.g., selected depth 52), “depth of compression” and “DOC” are used interchangeably to define the depth at which the stress in a substrate 10, as described herein, changes from compressive to tensile. DOC may be measured by a surface stress meter, such as a surface stress meter (e.g., model FSM-6000), or a scattered light polariscope (SCALP) depending on the ion exchange treatment. Where the stress in a substrate 10 having a glass-ceramic composition is generated by exchanging potassium ions into the glass substrate, a surface stress meter is used to measure DOC. Where the stress is generated by exchanging sodium ions into a glass-ceramic article, SCALP is used to measure DOC. Where the stress in the substrate 10 having a glass-ceramic composition is generated by exchanging both potassium and sodium ions into the glass-ceramic, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by a surface stress meter. As also used herein, the “maximum compressive stress” is defined as the maximum compressive stress within the compressive stress region 50 in the substrate 10. In some embodiments, the maximum compressive stress is obtained at or in close proximity to the one or more primary surfaces 12, 14 defining the compressive stress region 50. In other embodiments, the maximum compressive stress is obtained between the one or more primary surfaces 12, 14 and the selected depth 52 of the compressive stress region 50.

In some embodiments of the article 100, as depicted in exemplary form in FIG. 1, the substrate 10 is a chemically strengthened glass-ceramic composition. For example, the substrate 10 can be selected from a chemically strengthened alkali-doped, alumino-borate glass-ceramic having a compressive stress region 50 extending to a first selected depth 52 of greater than 10 μm, with a maximum compressive stress of greater than 150 MPa. In further embodiments, the substrate 10 has a compressive stress region 50 extending to a first selected depth 52 of greater than 25 μm, with a maximum compressive stress of greater than 400 MPa. The substrate 10 of the article 100 may also include one or more compressive stress regions 50 that extend from one or more of the primary surfaces 12, 14 to a selected depth 52 (or depths) having a maximum compressive stress of greater than about 150 MPa, greater than 200 MPa, greater than 250 MPa, greater than 300 MPa, greater than 350 MPa, greater than 400 MPa, greater than 450 MPa, greater than 500 MPa, greater than 550 MPa, greater than 600 MPa, greater than 650 MPa, greater than 700 MPa, greater than 750 MPa, greater than 800 MPa, greater than 850 MPa, greater than 900 MPa, greater than 950 MPa, greater than 1000 MPa, and all maximum compressive stress levels between these values. In some embodiments, the maximum compressive stress is 2000 MPa or lower. In addition, the depth of compression (DOC) or first selected depth 52 can be set at 10 μm or greater, 15 μm or greater, 20 μm or greater, 25 μm or greater, 30 μm or greater, 35 μm or greater, and to even higher depths, depending on the thickness of the substrate 10 and the processing conditions associated with generating the compressive stress region 50. In some embodiments, the DOC is less than or equal to 0.3 times the thickness (t) of the substrate 10, for example 0.3 t, 0.28 t, 0.26 t, 0.25 t, 0.24 t, 0.23 t, 0.22 t, 0.21 t, 0.20 t, 0.19 t, 0.18 t, 0.15 t, or 0.1 t.

Referring again to FIG. 1, the substrate 10 of the article 100 can be characterized by a glass-ceramic composition. In embodiments, the glass-ceramic composition of substrate 10 is given by: 5 mol %≤Al₂O₃≤40 mol %; 30 mol %≤B₂O₃≤60 mol %; 10 mol %≤WO₃≤50 mol %; 0 mol %≤SnO₂≤5 mol %; and 1 mol %≤R₂O≤30 mol %, wherein R₂O is one or more of Li₂O, Na₂O, K₂O, Rb₂O, and Cs₂O. In another aspect, the substrate 10 includes: 7 mol %≤Al₂O₃≤30 mol %; 35 mol %≤B₂O₃≤55 mol %; 15 mol %≤WO₃≤40 mol %; 0 mol %≤SnO₂≤2.5 mol %; and 5 mol %≤R₂O≤25 mol %. In a further aspect, the substrate 10 includes: 11.5 mol %≤Al₂O₃≤24.5 mol %; 44 mol %≤B₂O₃≤49 mol %; 20 mol %≤WO₃≤25 mol %; 0 mol %≤SnO₂≤0.25 mol %; and 13 mol %≤R₂O≤19.5 mol %. In an implementation of any of these substrates 10, R₂O is one or more of Li₂O and Na₂O. More generally, the glass-ceramic substrates 10 and articles 100 of the disclosure, as depicted in FIG. 1, are alkali-doped, alumino-borate systems with tungstate crystalline phase(s), along with chemically-strengthened versions of the substrates and articles.

In implementations, the glass-ceramic materials of the disclosure, including the substrate 10 employed in the article 100 (see FIG. 1), can comprise Al₂O₃ from about 5 mol % to about 40 mol %. According to some embodiments, the glass-ceramic materials can comprise Al₂O₃ from about 7 mol % to about 30 mol %. In another implementation, the glass-ceramic materials can comprise Al₂O₃ from about 11.5 mol % to about 24.5 mol %. Accordingly, the glass-ceramic materials of the disclosure can comprise Al₂O₃ from about 5 mol % to about 40 mol %, from about 5 mol % to about 35 mol %, from about 5 mol % to about 30 mol %, from about 5 mol % to about 25 mol %, from about 7 mol % to about 40 mol %, from about 7 mol % to about 35 mol %, from about 7 mol % to about 30 mol %, from about 7 mol % to about 25 mol %, from about 10 mol % to about 40 mol %, from about 10 mol % to about 35 mol %, from about 10 mol % to about 30 mol %, from about 10 mol % to about 25 mol %, from about 11.5 mol % to about 40 mol %, from about 11.5 mol % to about 35 mol %, from about 11.5 mol % to about 30 mol %, from about 11.5 mol % to about 25 mol %, from about 11.5 mol % to about 24.5 mol %, and all Al₂O₃ amounts between these range endpoints.

According to implementations, the glass-ceramic materials of the disclosure, including the substrate 10 employed in the article 100 (see FIG. 1), can comprise B₂O₃ from about 30 mol % to about 60 mol %. According to some embodiments, the glass-ceramic materials can comprise B₂O₃ from about 35 mol % to about 55 mol %. In another implementation, the glass-ceramic materials can comprise B₂O₃ from about 44 mol % to about 49 mol %. Accordingly, the glass-ceramic materials of the disclosure can comprise B₂O₃ from about 30 mol % to about 60 mol %, from about 30 mol % to about 57.5 mol %, from about 30 mol % to about 55 mol %, from about 30 mol % to about 52.5 mol %, from about 30 mol % to about 50 mol %, from about 30 mol % to about 49 mol %, from about 35 mol % to about 60 mol %, from about 35 mol % to about 57.5 mol %, from about 35 mol % to about 55 mol %, from about 35 mol % to about 52.5 mol %, from about 35 mol % to about 50 mol %, from about 35 mol % to about 49 mol %, from about 44 mol % to about 60 mol %, from about 44 mol % to about 57.5 mol %, from about 44 mol % to about 55 mol %, from about 44 mol % to about 52.5 mol %, from about 44 mol % to about 50 mol %, from about 44 mol % to about 49 mol %, and all B₂O₃ amounts between these range endpoints.

According to implementations, the glass-ceramic materials of the disclosure, including the substrate 10 employed in the article 100 (see FIG. 1), can comprise WO₃ from about 10 mol % to about 50 mol %. According to some embodiments, the glass-ceramic materials can comprise WO₃ from about 15 mol % to about 40 mol %. In another implementation, the glass-ceramic materials can comprise WO₃ from about 20 mol % to about 25 mol %. Accordingly, the glass-ceramic materials of the disclosure can comprise WO₃ from about 10 mol % to about 50 mol %, from about 10 mol % to about 45 mol %, from about 10 mol % to about 40 mol %, from about 10 mol % to about 35 mol %, from about 10 mol % to about 30 mol %, from about 10 mol % to about 25 mol %, from 15 mol % to about 50 mol %, from about 15 mol % to about 45 mol %, from about 15 mol % to about 40 mol %, from about 15 mol % to about 35 mol %, from about 15 mol % to about 30 mol %, from about 15 mol % to about 25 mol %, from 20 mol % to about 50 mol %, from about 20 mol % to about 45 mol %, from about 20 mol % to about 40 mol %, from about 20 mol % to about 35 mol %, from about 20 mol % to about 30 mol %, from about 20 mol % to about 25 mol %, and all WO₃ amounts between these range endpoints.

In further implementations, the glass-ceramic materials of the disclosure, including the substrate 10 employed in the article 100 (see FIG. 1), can comprise one or more of SnO₂, P₂O₅, and ZnO₂ from about 0 mol % to 5 mol %, from about 0 mol % to 4 mol %, from about 0 mol % to 3 mol %, from about 0 mol % to about 2.5 mol %, from about 0 mol % to about 2 mol %, from about 0 mol % to about 1 mol %, from about 0 mol % to about 0.5 mol %, from about 0 mol % to about 0.45 mol %, from about 0 mol % to about 0.4 mol %, from about 0 mol % to about 0.35 mol %, from about 0 mol % to about 0.3 mol %, from about 0 mol % to about 0.25 mol %, from about 0 mol % to about 0.2 mol %, from about 0 mol % to about 0.15 mol %, from about 0 mol % to about 0.1 mol %, from about 0 mol % to about 0.05 mol %, and all values of SnO₂, P₂O₅, and/or ZnO₂ between these values.

In further implementations, the glass-ceramic materials of the disclosure, including the substrate 10 employed in the article 100 (see FIG. 1), can comprise an alkali metal oxide (R₂O) from about 1 mol % to about 30 mol %, from about 5 mol % to about 25 mol %, from about 10 mol % to about 22.5 mol %, from about 10 mol % to about 20 mol %, from about 12 mol % to about 20 mol %, from about 13 mol % to about 19.5 mol %, and all values of R₂O between these values, wherein R₂O is one or more of Li₂O, Na₂O, K₂O, Rb₂O and Cs₂O. For example, R₂O can be 1 mol %, 2 mol %, 3 mol %, 4 mol %, 5 mol %, 7.5 mol %, 10 mol %, 12.5 mol %, 15 mol %, 17.5 mol %. 20 mol %, 22.5 mol %, 25 mol %, 27.5 mol %, 30 mol %, and all values of R₂O between these values.

In some embodiments, the glass-ceramic materials of the disclosure are substantially cadmium- and/or selenium-free. In embodiments, the glass-ceramic can further comprise at least one dopant selected from the group consisting of H, S, Cl, Ti, V, Cr, Mn, Fe, Co, Ni, Cu, Ga, Se, Br, Zr, Nb, Ru, Rh, Pd, Ag, Cd, In, Sb, Te, I, La, Ce, Pr, Nd, Sm, Eu, Gd, Tb, Dy, Ho, Er, Tm, Yb, Lu, Ta, Os, Ir, Pt, Au, Tl, Pb, Bi, and U. In some embodiments, the at least one dopant is present in the glass-ceramic from about 0 mol % to about 0.5 mol %.

According to further embodiments of the disclosure, glass-ceramic materials, including the substrate 10 employed in the article 100 depicted in FIG. 1, can comprise a glassy phase and at least one crystalline phase selected from the group consisting of a stoichiometric crystalline phase, a non-stoichiometric crystalline phase and a mixed stoichiometric and non-stoichiometric crystalline phase. Further, these glass-ceramic materials have crystalline phases that typically have dimensions on a nanoscale level and can be characterized as non-stoichiometric tungsten oxides (also referred herein as “bronzes”). Though called a “bronze,” these glass-ceramic materials are not structurally or chemically related to metallic bronze, which is an alloy of copper and tin. Rather, the term “bronze,” as it relates to the tungsten bronzes of the disclosure, was originally associated with the larger family of these materials, which includes sodium tungsten bronze which at a certain stoichiometric range is characterized by a brilliant, lustrous yellow color similar in hue to metallic bronzes.

In some implementations of the foregoing glass-ceramic materials of the disclosure, including the substrate 10 employed in the article 100 depicted in FIG. 1, the crystalline phase can comprise a crystalline phase of MₓWO₃, wherein M is at least one of H, NH₄, Li, Na, K, Rb, Cs, Mg, Ca, Sn, Ag, Ln, and 0≤x≤1. The structure, MₓWO₃ is considered to be a solid-state defect structure in which holes in a reduced WO₃ network are randomly occupied by M atoms, which are dissociated into M+ cations and free electrons. Depending on the concentration of “M”, the material properties can range from metallic to semi-conducting. The optical properties of tungsten bronze also can be tuned by selecting the dopant species and its concentration. For dopant M=Na and x=0.93, the color is a bronze-like golden-yellow, hence termed a “tungsten bronze”. At lower dopant concentrations (e.g., M=Cs and x=0.32) the compound exhibits a deep blue-violet color, which strongly attenuates red and near infrared wavelengths.

According to some embodiments of the disclosure, including the substrate 10 employed in the article 100 depicted in FIG. 1, the crystalline phase(s) can comprise crystallites that range in size from 5 nm to 200 nm, 5 nm to 150 nm, 5 nm to 100 nm, and all sizes between these ranges, as observed in transmission electron microscopy (TEM). In some implementations, the crystalline phase(s) of these glass-ceramic materials are uniformly distributed throughout the thickness of the glass-ceramic, e.g., through the thickness 102 of the substrate 10. Without being bound by theory, it is believed that the crystalline phases of the glass-ceramic compositions of the disclosure can form through internal nucleation upon a heat treating (i.e., ceramming) step that is conducted after melting and annealing. Indeed, some compositions can be engineered to spontaneously crystallize internally during cooling from the melt. These still result in finely divided nanometer scale crystals.

In some implementations, the substrate 10 depicted in FIG. 1 includes a glass-ceramic composition of the disclosure, e.g., a silica-free tungsten bronze composition, such that the article 100 has UV- and NIR-blocking attributes, and can be used in various applications including, but not limited to, optical filters, lenses, and glazing for automotive, architectural, medical, defense, aerospace, and other consumer applications. These glazing applications include solar shielding, e.g., as employed in automotive and architectural applications. In some implementations, the glass-ceramic compositions of the disclosure can be ground into frit and used in a laser scaling application. In these implementations, an appropriate laser is used with a UV and/or NIR spectral range such that it can locally heat the glass-ceramic (given its high UV and NIR absorbance) and melt it such that it can function as a glass-ceramic frit seal.

The substrate 10 of the article 100 depicted in FIG. 1 can be made according to a method of making a glass-ceramic, according to some embodiments of the disclosure. In the method, a batch is mixed with the following composition of precursor constituents: 5 mol %≤Al₂O₃≤40 mol %; 30 mol %≤B₂O₃≤60 mol %; 10 mol %≤WO₃≤50 mol %; 0 mol %≤SnO₂≤5 mol %; and 1 mol %≤R₂O≤30 mol %, wherein R₂O is one or more of Li₂O, Na₂O, K₂O, Rb₂O, and Cs₂O. In some embodiments, the batch is silica-free. The mixing can be conducted by turbula mixing the batch for about 10 to 120 minutes, 10 to 60 minutes, or 10 to 30 minutes, e.g., 15 minutes.

The next step in the method is to melt the batch, e.g., from about 1050° C. to 1500° C., from about 1100° C. to 1450° C., or other temperature range within the foregoing ranges, to form a melt. In some embodiments, the batch is melted in a platinum or other suitable refractory crucible. Optionally, the melting can be conducted with a second melting step, usually from about 1250° C. to 1450° C., to melt any portions of the batch that remain un-melted after the first melting step. Advantageously, these melting temperatures are substantially lower than melting temperatures necessary to melt comparative tungsten bronze compositions containing appreciable amounts of silica. The duration of the melting step for the method of making the glass-ceramics of the disclosure is from about 5 to 120 minutes, or other suitable duration as would be understood by those skilled in the field of the disclosure, particularly in view of the crucible and heating apparatus employed in the method.

The method of making the glass-ceramics of the disclosure, e.g., the substrate 10 employed in the article 100 depicted in FIG. 1, includes a step of annealing the melt from about 380° C. to about 500° C. or, from about 380° C. to about 450° C., and all annealing temperatures between these ranges, to define an annealed melt. The annealed melt remains in the form of a glass. In embodiments, the melt from the prior step is cast onto a steel table and then the melt is subjected to the annealing step. The duration of the annealing step for the method of making the glass-ceramics of the disclosure is from about 5 to 120 minutes, or other suitable duration as would be understood by those skilled in the field of the disclosure, particularly in view of the crucible and heating apparatus employed in the method.

The method of making the glass-ceramics of the disclosure, e.g., the substrate 10 employed in the article 100 depicted in FIG. 1, further includes a step of heat treating (also referred to interchangeably as “ceramming”) the annealed melt between about 500° C. and about 1000° C. from about 5 minutes to about 48 hours to form the glass-ceramic. In embodiments, the heat treating step is conducted at or slightly above the annealing point of the glass-ceramic, and below its softening point, to develop one or more crystalline tungstate phases. In some embodiments, the annealed melt is heat treated between about 600° C. and about 800° C. from about 5 minutes to about 24 hours to form the glass-ceramic. According to some embodiments, the annealed melt is heat treated between about 650° C. and about 725° C. from about 45 minutes to about 3 hours to form the glass-ceramic. In another implementation, the annealed melt is heat treated according to a temperature and time to obtain particular optical properties, e.g., the various total transmittance levels outlined earlier in the disclosure within the visible spectrum, NIR spectrum and UV spectrum. In a further implementation, the heat treating is conducted in a reducing atmosphere (e.g., an inert, non-oxidizing atmosphere).

According to some embodiments, the glass-ceramic that results from the foregoing method includes a glassy phase and at least one crystalline phase. Further, the at least one crystalline phase can comprise crystallites that range in size from 5 nm to 200 nm or from 5 nm to 100 nm, as observed in TEM. In some implementations, the crystalline phase(s) of these glass-ceramic materials are uniformly distributed throughout the thickness of the glass-ceramic. Ultimately, the glass-ceramic materials formed according to the method, as sized to a thickness from about 0.05 mm to 0.5 mm or 0.5 mm to 5 mm, can exhibit one or more of: (a) a total transmittance of less than or equal to 4% at UV wavelengths below 400 nm and (b) a total transmittance from about 0.5% to about 4% in the NIR spectrum from 700 nm to 1500 nm. Further, the GC materials and articles of the disclosure can exhibit a total transmittance of at least 0.5% in the visible (VIS) spectrum from 400 nm to 700 nm.

### EXAMPLES

The following examples represent certain non-limiting examples of the glass-ceramic materials and articles of the disclosure, including the methods of making them.

### Example 1

In this example, inventive glass-ceramic compositions were formed with the nine (9) compositions denoted below in Table 1, designated “Exs. 1A-1I”. In particular, constituents of these examples were batched according to their respective mole percent listed in Table 1. In particular, these compositions were prepared by weighing the requisite oxides, turbula mixing them for 15 minutes, and then melting the resulting batch in platinum crucibles at a temperature of 1100° C. The melts were fluid and homogenous with only two exceptions, Exs. 1B and 1E, which contained relatively higher amounts of Al₂O₃. These compositions (Exs. 1B and 1E) were re-melted at 1400° C., which ensured that these compositions also had homogeneous fluid melts. Further, all of the melts associated with these nine (9) compositions were cast onto a steel table and then annealed at temperatures between 380° C. and 500° C. to form annealed melts. Finally, portions of these annealed melts were then subjected to a heat treating step between 500° C. and about 1000° C. for a duration between 5 minutes and 48 hours to form glass-ceramics with the compositions denoted below in Table 1.

TABLE 1
Inventive glass-ceramic compositions in as-batched mole percent (%)

| Oxides | Ex. 1A | Ex. 1B | Ex. 1C | Ex. 1D | Ex. 1E | Ex. 1F | Ex. 1G | Ex. 1H | Ex. 1I |
|---|---|---|---|---|---|---|---|---|---|
| B₂O₃ | 44 | 44 | 44 | 49 | 49 | 49 | 49 | 44 | 48.9 |
| Al₂O₃ | 18 | 24.5 | 11.5 | 18 | 24.5 | 11.5 | 15.5 | 18 | 18 |
| Li₂O | 13 | 6.5 | 19.5 | 13 | 6.5 | 19.5 | 15.5 | 0 | 13 |
| Na₂O | 0 | 0 | 0 | 0 | 0 | 0 | 0 | 13 | 0 |
| WO₃ | 25 | 25 | 25 | 20 | 20 | 20 | 20 | 25 | 20 |
| SnO₂ | 0 | 0 | 0 | 0 | 0 | 0 | 0 | 0 | 0.15 |

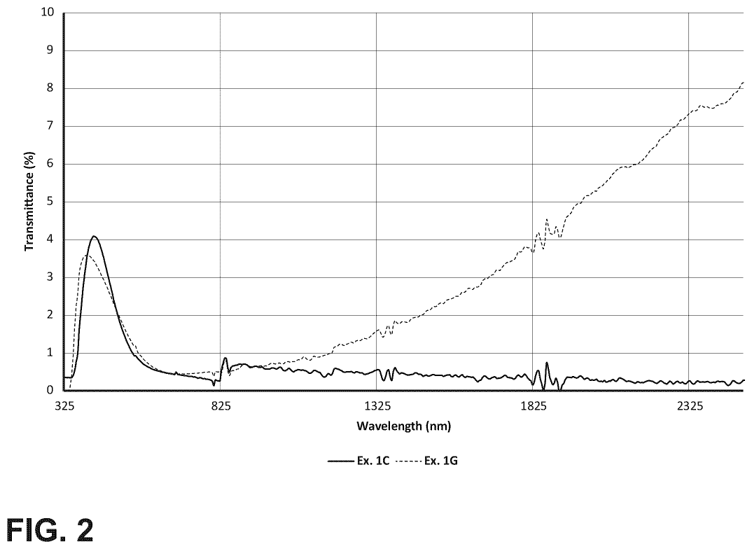

Referring now to FIG. 2, a plot is provided of the optical transmission spectra for two of the glass-ceramic compositions listed in Table 1, Exs. 1C and 1G, in the annealed melt state (i.e., without the heat treating or ceramming step). Notably, the spectra are nearly identical in shape to prior, comparative tungsten bronze glass ceramics that contain silica. Further, the optical spectra in FIG. 2 suggest that the crystalline phases present (or that will develop through a heat treating step) are alkali-doped tungsten bronzes.

As is evident from FIG. 2, these compositions exhibit some visible transmittance and possess strong UV and NIR absorbance. More specifically, it is evident that each of these glass-ceramic compositions exhibit: (a) a total transmittance of less than or equal to 4% at UV wavelengths below 400 nm; and (b) a total transmittance from about 0.5% to about 4% in the NIR spectrum from 700 nm to 1500 nm. Further, these glass-ceramic compositions exhibit a total transmittance of at least 0.5% in the visible spectrum from 400 nm to 700 nm.

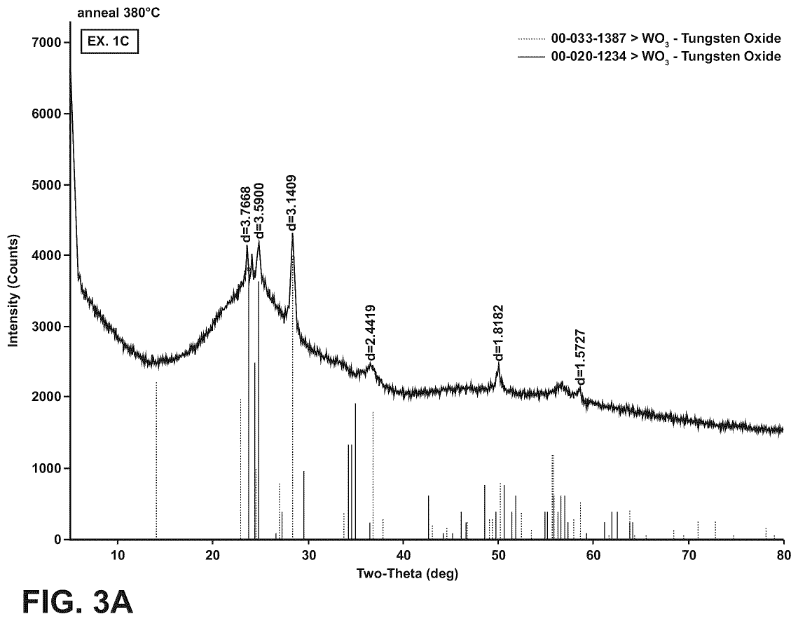

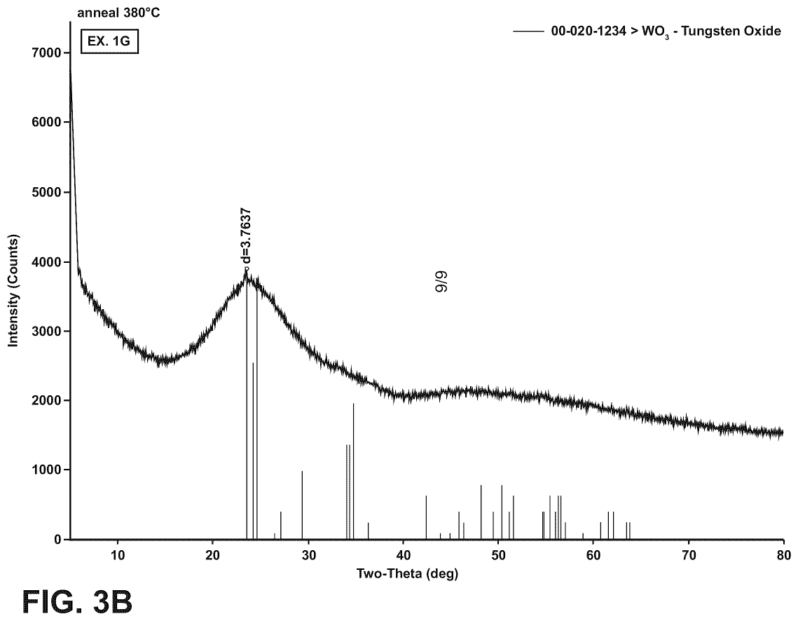

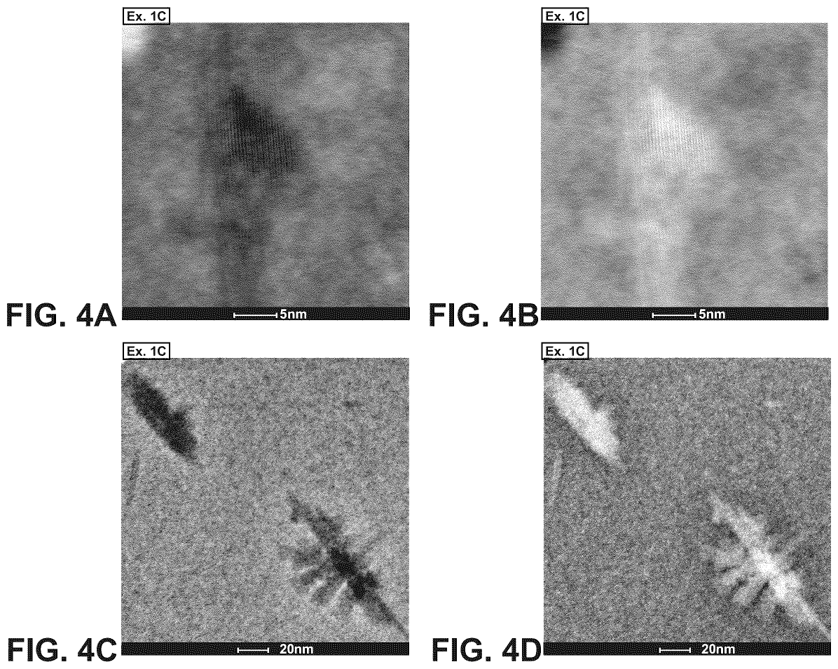

Referring now to FIGS. 3A and 3B, respective x-ray diffraction (XRD) plots are provided for the two glass-ceramic compositions of FIG. 2, Exs. 1C and 1G (see also Table 1 above), as measured in the glass-ceramic state after the heat treating step. These XRD profiles suggest that the crystalline phase(s) of these glass-ceramic compositions is WO₃ (e.g., a tungstate or tungsten oxide). Without being bound by theory, it is believed that the difference in interpreted crystalline phases present in these glass-ceramic compositions as viewed in FIGS. 2, 3A and 3B is because alkali-doped tungsten bronzes can appear as WO₃ because the doping from the alkali results in only small shifts in the d spacing in the crystal. This is further compounded by the fact that the crystallites are nanoscopic (e.g., as shown below in FIGS. 4A-4D), which makes identification by XRD more challenging.

Referring now to FIGS. 4A-4D, transmission electron microscopy (TEM) micrographs are provided of one of the glass-ceramic compositions of Table 1, Ex. 1C. In particular, these TEM micrographs are taken from different samples of the same Ex. 1C glass-ceramic composition, after the heat treating step. As is evident from FIGS. 4A-4D, the observed crystallites are on the nanoscopic scale and range in size from about 5 nm (see FIGS. 4A and 4B, top row) to about 50 to 100 nm (see FIGS. 4C and 4D, bottom row).

### Comparative Example 1

In this example, a comparative glass composition is formed with the composition denoted below in Table 2, designated “Comp. Ex. 1”. In particular, constituents of this comparative example were batched according to the mole percent listed in Table 2. The composition was prepared by weighing the requisite oxides, turbula mixing them for 15 minutes, and then melting the resulting batch in a platinum crucible at a temperature of 1600° C. for three hours. The melt was fluid and homogenous. Next, the melt associated with this comparative composition was cast onto a steel table and then annealed at 700° C. to form an annealed glass. Finally, portions of the annealed glass were subjected to a heat treating step between 500° C. and about 1000° C. for a duration between 5 minutes and 48 hours to form a glass with the composition denoted below in Table 2.

TABLE 2
Comparative glass composition in as-batched mole percent (%)

| Oxides | Comp. Ex. 1 |
|---|---|
| Al₂O₃ | 20 mol % |
| WO₃ | 10 mol % |
| P₂O3 | 70 mol % |

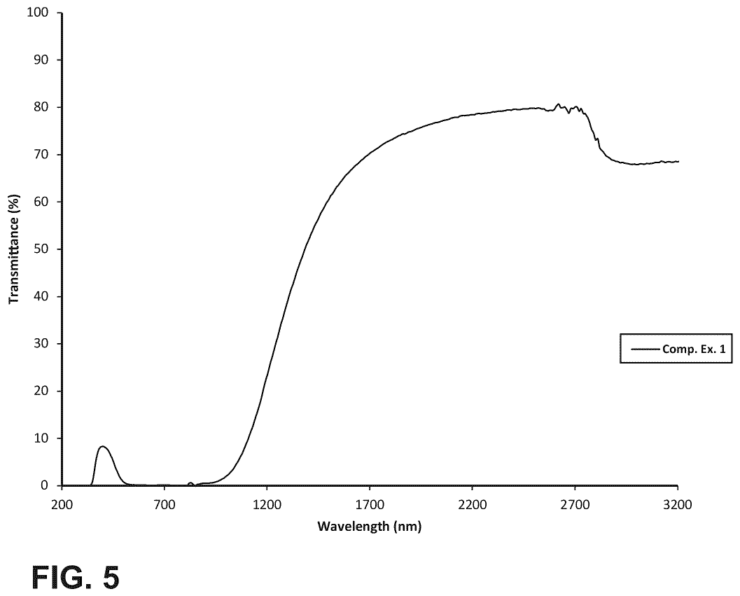

Referring now to FIG. 5, a plot is provided of an optical transmission spectrum for a tungsten-containing glass (Comp. Ex. 1). This comparative glass is a tungsten-rich, silica-free ternary glass comprised of 20 mol % Al₂O₃, 10 mol % WO₃, and 70 mol % P₂O₅ that exhibits a blue color due to its reduced tungsten 5+ ion. However, as is evident from FIG. 5, this glass composition lacks appreciable NIR absorption.

The various features described in the specification may be combined in any and all combinations, for example, as listed in the following embodiments.
Embodiment 1. A glass-ceramic is provided that includes: 5 mol %≤Al₂O₃≤40 mol %; 30 mol %≤B₂O₃≤60 mol %; 10 mol %≤WO₃≤50 mol %; 0 mol %≤SnO₂≤5 mol %; and 1 mol %≤R₂O≤30 mol %, wherein R₂O is one or more of Li₂O, Na₂O, K₂O, Rb₂O, and Cs₂O.
Embodiment 2. The glass ceramic of Embodiment 1 is provided, wherein R₂O is one or both of Li₂O and Na₂O.
Embodiment 3. The glass ceramic of Embodiment 1 or Embodiment 2 is provided, wherein the glass-ceramic is silica-free.
Embodiment 4. The glass-ceramic of any one of Embodiments 1-3 is provided, wherein the glass-ceramic comprises a glassy phase and at least one crystalline phase, and further wherein the at least one crystalline phase comprises crystallites that range in size from 5 nm to 100 nm, as observed in transmission electron microscopy.
Embodiment 5. The glass-ceramic of Embodiment 4 is provided, wherein the at least one crystalline phase is uniformly distributed throughout a thickness of the glass-ceramic.
Embodiment 6. The glass-ceramic of any one of Embodiments 1-5 is provided, wherein the glass-ceramic comprises a thickness from about 0.05 mm to about 0.5 mm and one or more of: (a) a total transmittance of less than or equal to 4% at ultraviolet wavelengths below 400 nm and (b) a total transmittance from about 0.5% to about 4% in the near-infrared spectrum from 700 nm to 1500 nm.
Embodiment 7. The glass-ceramic of Embodiment 6 is provided, wherein the glass-ceramic further comprises a total transmittance of at least 0.5% in the visible spectrum from 400 nm to 700 nm.
Embodiment 8. A solar shield is provided that includes the glass-ceramic of any one of Embodiments 1-7.
Embodiment 9. A glass-ceramic is provided that includes: 7 mol %≤Al₂O₃≤30 mol %; 35 mol %≤B₂O₃≤55 mol %; 15 mol %≤WO₃≤40 mol %; 0 mol %≤SnO₂≤2.5 mol %; and 5 mol %≤R₂O≤25 mol %, wherein R₂O is one or more of Li₂O, Na₂O, K₂O, Rb₂O, and Cs₂O.
Embodiment 10. The glass-ceramic of Embodiment 9 is provided, wherein R₂O is one or both of Li₂O and Na₂O.
Embodiment 11. The glass-ceramic of Embodiment 9 or Embodiment 10 is provided, wherein the glass-ceramic is silica-free.
Embodiment 12. The glass-ceramic of any one of Embodiments 9-11 is provided, wherein the glass-ceramic comprises a glassy phase and at least one crystalline phase, and further wherein the at least one crystalline phase comprises crystallites that range in size from 5 nm to 100 nm, as observed in transmission electron microscopy.
Embodiment 13. The glass-ceramic of Embodiment 12 is provided, wherein the at least one crystalline phase is uniformly distributed throughout a thickness of the glass-ceramic.
Embodiment 14. The glass-ceramic of any one of Embodiments 9-13 is provided, further comprising 11.5 mol %≤Al₂O₃≤24.5 mol %; 44 mol %≤B₂O₃≤49 mol %; 20 mol %≤WO₃≤25 mol %; 0 mol %≤SnO₂≤0.25 mol %; and 13 mol %≤R₂O≤19.5 mol %, wherein R₂O is one or more of Li₂O, Na₂O, K₂O, Rb₂O, and Cs₂O.
Embodiment 15. The glass-ceramic of any one of Embodiments 9-14 is provided, wherein the glass-ceramic comprises a thickness from about 0.05 mm to about 0.5 mm and one or more of: (a) a total transmittance of less than or equal to 4% at ultraviolet wavelengths below 400 nm and (b) a total transmittance from about 0.5% to about 4% in the near-infrared spectrum from 700 nm to 1500 nm.
Embodiment 16. The glass-ceramic of any one of Embodiments 9-14 is provided, wherein the glass-ceramic comprises a thickness from about 0.05 mm to about 0.5 mm and one or more of: (a) a total transmittance of less than or equal to 3.5% at ultraviolet wavelengths below 400 nm and (b) a total transmittance from about 0.5% to about 2.5% in the near-infrared spectrum from 700 nm to 1500 nm.
Embodiment 17. The glass-ceramic of any one of Embodiments 9-14 is provided, wherein the glass-ceramic comprises a thickness from about 0.05 mm to about 0.5 mm and one or more of: (a) a total transmittance of less than or equal to 3.5% at ultraviolet wavelengths below 400 nm and (b) a total transmittance from about 0.5% to about 9% in the near-infrared spectrum from 700 nm to 2400 nm.
Embodiment 18. The glass-ceramic of any one of Embodiments 9-17 is provided, wherein the glass-ceramic further comprises a total transmittance of at least 0.5% in the visible spectrum from 400 nm to 700 nm.
Embodiment 19. A solar shield is provided that includes the glass-ceramic of any one of Embodiments 9-18.
Embodiment 20. A method of making a glass-ceramic is provided that includes the following steps: mixing a batch comprising: 5 mol %≤Al₂O₃≤40 mol %; 30 mol %≤B₂O₃≤60 mol %; 10 mol %≤WO₃≤50 mol %; 0 mol %≤SnO₂≤5 mol %; and 1 mol %≤R₂O≤30 mol %, wherein R₂O is one or more of Li₂O, Na₂O, K₂O, Rb₂O, and Cs₂O; melting the batch between about 1100° C. and about 1450° C. to form a melt; annealing the melt between about 380° C. and about 500° C. to define an annealed melt; and heat treating the annealed melt between about 500° C. and about 1000° C. from about 5 minutes to about 48 hours to form the glass-ceramic.
Embodiment 21. The method of Embodiment 20 is provided, wherein the glass-ceramic is silica-free.
Embodiment 22. The method of Embodiment 20 or Embodiment 21 is provided, wherein the glass-ceramic comprises a glassy phase and at least one crystalline phase, and further wherein the at least one crystalline phase comprises crystallites that range in size from 5 nm to 100 nm, as observed in transmission electron microscopy.
Embodiment 23. The method of any one of Embodiments 20-22 is provided, wherein the at least one crystalline phase is uniformly distributed throughout a thickness of the glass-ceramic.
Embodiment 24. The method of any one of Embodiments 20-23 is provided, wherein the heat treating is conducted in a reducing atmosphere.
Embodiment 25. The method of any one of Embodiments 20-24 is provided, wherein the glass-ceramic comprises a thickness from about 0.05 mm to about 0.5 mm and one or more of: (a) a total transmittance of less than or equal to 4% at ultraviolet wavelengths below 400 nm and (b) a total transmittance from about 0.5% to about 4% in the near-infrared spectrum from 700 nm to 1500 nm.

What is claimed is:

1. A glass-ceramic, comprising:
5 mol %≤Al₂O₃≤40 mol %;
30 mol %≤B₂O₃≤60 mol %;
10 mol %≤WO₃≤50 mol %;
0 mol %≤SnO₂≤5 mol %; and
1 mol %≤R₂O≤30 mol %,
wherein R₂O is at least one of Li₂O, Na₂O, K₂O, Rb₂O, or Cs₂O.

2. The glass-ceramic of claim 1, wherein R₂O is at least one of Li₂O or Na₂O.

3. The glass-ceramic of claim 1, wherein the glass-ceramic is silica-free.

4. The glass-ceramic of claim 1, wherein the glass-ceramic comprises a glassy phase and at least one crystalline phase, and further wherein the at least one crystalline phase comprises crystallites that range in size from 5 nm to 100 nm, as observed in transmission electron microscopy.

5. The glass-ceramic of claim 4, wherein the at least one crystalline phase is uniformly distributed throughout a thickness of the glass-ceramic.

6. The glass-ceramic of claim 1, wherein the glass-ceramic comprises a thickness from about 0.05 mm to about 0.5 mm and at least one of: (a) a total transmittance of less than or equal to 4% at ultraviolet wavelengths below 400 nm, or (b) a total transmittance from about 0.5% to about 4% in the near-infrared spectrum from 700 nm to 1500 nm.

7. The glass-ceramic of claim 6, wherein the glass-ceramic further comprises a total transmittance of at least 0.5% in the visible spectrum from 400 nm to 700 nm.

8. A solar shield comprising the glass-ceramic of claim 1.

9. A glass-ceramic, comprising:
7 mol %≤Al₂O₃≤30 mol %;
35 mol %≤B₂O₃≤55 mol %;
15 mol %≤WO₃≤40 mol %;
0 mol %≤SnO₂≤2.5 mol %; and
5 mol %≤R₂O≤25 mol %,
wherein R₂O is at least one of Li₂O, Na₂O, K₂O, Rb₂O, or Cs₂O.

10. The glass-ceramic of claim 9, wherein R₂O is at least one of Li₂O or Na₂O.

11. The glass-ceramic of claim 9, wherein the glass-ceramic is silica-free.

12. The glass-ceramic of claim 9, wherein the glass-ceramic comprises a glassy phase and at least one crystalline phase, and further wherein the at least one crystalline phase comprises crystallites that range in size from 5 nm to 100 nm, as observed in transmission electron microscopy.

13. The glass-ceramic of claim 12, wherein the at least one crystalline phase is uniformly distributed throughout a thickness of the glass-ceramic.

14. The glass-ceramic of claim 9, further comprising:
11.5 mol %≤Al₂O₃≤24.5 mol %;
44 mol %≤B₂O₃≤49 mol %;
20 mol %≤WO₃≤25 mol %;
0 mol %≤SnO₂≤0.25 mol %; and
13 mol %≤R₂O≤19.5 mol %,
wherein R₂O is at least one of Li₂O, Na₂O, K₂O, Rb₂O, or Cs₂O.

15. The glass-ceramic of claim 9, wherein the glass-ceramic comprises a thickness from about 0.05 mm to about 0.5 mm and at least one of: (a) a total transmittance of less than or equal to 4% at ultraviolet wavelengths below 400 nm, or (b) a total transmittance from about 0.5% to about 4% in the near-infrared spectrum from 700 nm to 1500 nm.

16. The glass-ceramic of claim 9, wherein the glass-ceramic comprises a thickness from about 0.05 mm to about 0.5 mm and at least one of: (a) a total transmittance of less than or equal to 3.5% at ultraviolet wavelengths below 400 nm, or (b) a total transmittance from about 0.5% to about 2.5% in the near-infrared spectrum from 700 nm to 1500 nm.

17. The glass-ceramic of claim 9, wherein the glass-ceramic comprises a thickness from about 0.05 mm to about 0.5 mm and at least one of: (a) a total transmittance of less than or equal to 3.5% at ultraviolet wavelengths below 400 nm, or (b) a total transmittance from about 0.5% to about 9% in the near-infrared spectrum from 700 nm to 2400 nm.

18. The glass-ceramic of claim 9, wherein the glass-ceramic further comprises a total transmittance of at least 0.5% in the visible spectrum from 400 nm to 700 nm.

19. A solar shield comprising the glass-ceramic of claim 9.

20. A method of making a glass-ceramic, comprising:
mixing a batch comprising:
5 mol %≤Al₂O₃≤40 mol %;
30 mol %≤B₂O₃≤60 mol %;
10 mol %≤WO₃≤50 mol %;
0 mol %≤SnO₂≤5 mol %; and
1 mol %≤R₂O≤30 mol %,
wherein R₂O is at least one of Li₂O, Na₂O, K₂O, Rb₂O, or Cs₂O;
melting the batch between about 1100° C. and about 1450° C. to form a melt;
annealing the melt between about 380° C. and about 500° C. to define an annealed melt; and
heat treating the annealed melt between about 500° C. and about 1000° C. from about 5 minutes to about 48 hours to form the glass-ceramic.

21. The method of claim 20, wherein the glass-ceramic is silica-free.

22. The method of claim 20, wherein the glass-ceramic comprises a glassy phase and at least one crystalline phase, and further wherein the at least one crystalline phase comprises crystallites that range in size from 5 nm to 100 nm, as observed in transmission electron microscopy.

23. The method of claim 20, wherein the at least one crystalline phase is uniformly distributed throughout a thickness of the glass-ceramic.

24. The method of claim 20, wherein the heat treating is conducted in a reducing atmosphere.

25. The method of claim 20, wherein the glass-ceramic comprises a thickness from about 0.05 mm to about 0.5 mm and at least one of: (a) a total transmittance of less than or equal to 4% at ultraviolet wavelengths below 400 nm, or (b) a total transmittance from about 0.5% to about 4% in the near-infrared spectrum from 700 nm to 1500 nm.
